(19) United States
(12) Patent Application Publication
(10) Pub. No.: US 2018/0374416 A1
(43) Pub. Date: Dec. 27, 2018

(54) DISPLAY DRIVING APPARATUS AND OPERATING METHOD THEREOF

(71) Applicant: Raydium Semiconductor Corporation, Hsinchu (TW)

(72) Inventors: Chun-Lin HOU, Hsinchu City (TW); Shao-Ping HUNG, Hsinchu City (TW); Shang-Ping TANG, Zhubei City (TW)

(21) Appl. No.: 16/013,112

(22) Filed: Jun. 20, 2018

Related U.S. Application Data
(60) Provisional application No. 62/522,756, filed on Jun. 21, 2017.

(51) Int. Cl. G09G 3/3225

(52) U.S. Cl. CPC G09G 3/3225; G09G 2320/0252; G09G 2310/04; G09G 2330/021; G09G 2310/08; G09G 2320/0247

(57) ABSTRACT

A display driving apparatus applied to a panel. The panel displays a first image with a first refresh rate. A first refresh cycle corresponding to the first refresh rate includes a refresh period and at least one non-refresh period. The display driving apparatus includes a real-time determination module and a data processing module. The real-time determination module is coupled to the panel and used to immediately determine whether the panel wants to replace the originally displayed first image with a second image during the first refresh cycle. The data processing module is coupled to the real-time determination module and the panel. If a determination result of the real-time determination module is yes, the data processing module immediately controls the panel to start to display the second image at a first time during the first refresh cycle.

### BACKGROUND OF THE INVENTION

### 1. Field of the Invention

The invention relates to a panel; in particular, to a display driving apparatus and an operating method thereof.

### 2. Description of the Prior Art

In general, in order to reduce the power consumption of the display apparatus, the power consumption is usually reduced by reducing the display refresh rate. For example, the display refresh rate can be reduced from the original 60 frames per second to 15 frames per second, that is, the number of display refreshes per second is reduced to ¼ of the original, and all display-related signals (e.g., the source driver output data and the gate-on-array (GOA) signals) can be stopped during the idle period to reduce power consumption.

For a self-luminous display panel, such as an active matrix organic light-emitting diode (AMOLED) panel, the display refresh rate may be reduced in various different ways. For example, FIG. 1 illustrates an embodiment of using the skip frame method to reduce the display refresh rate. It should be noted that, in the drawings of the present invention, X in the box is used to represent skipping this display frame without refreshing.

As shown in FIG. 1, if a first display refresh rate RF1 (60 Hz) is a unit time (that is, 16.67 milliseconds) and a cycle of refreshing a unit time (e.g., the refresh period T2) and then not refreshing three unit times (e.g., the non-refresh period T3) is repeated continuously, that is equivalent to reducing the original first display refresh rate RF1 (60 Hz) to the second display refresh rate RF2 (15 Hz). Therefore, when the display frame F1 is refreshed, there will be three consecutive display frames not refreshed (represented by X in the box in FIG. 1); when the display frame F5 is refreshed, there are also three consecutive display frames not refreshed (represented by X in the box in FIG. 1), and so on.

When this method is used, it is not necessary to adjust the setting of the related display signal when changing the display refresh rate. Therefore, it is less likely to affect the display quality of some display devices sensitive to the timing of display signals.

For the purpose of power saving, when the skip frame method is used to reduce the display refresh rate, all display signals are usually stopped during the non-refresh period T3, such as the gate scan signal GS shown in FIG. 1 and the emission control signal EC related to the panel display lightness will be in the normal operation state A during the refresh period T2 and in the stop-operation state S during the non-refresh period T3.

However, for the self-luminous panel such as the AMOLED panel, if the emission control signal EC responsible for controlling the light-emitting time of the OLED is in the stop-operation state S during the non-refresh period T3, it will cause the image displayed on the self-luminous panel during the refresh period T2 and the non-refresh period T3 will have great lightness difference, and thus the phenomenon of flicker appears, and it is necessary to overcome it.

In addition, as shown in FIG. 2, when the skip frame method is used to reduce the display refresh rate, if the display screen is to be changed from the original first image M1 to the second image M2, the second image M2 will be written in started during the refresh period T1 of the first image M1. When the second image M2 is written in at the time tn, it still needs a waiting time TW until the end of the non-refresh period T3, the display screen will be refreshed to the second image M2 at the time t8. It is easy to cause the display screen to be delayed or not smooth when the display refresh rate is low, which needs to be overcome.

### SUMMARY OF THE INVENTION

Therefore, the invention provides a display driving apparatus and an operating method thereof to solve the above-mentioned problems of the prior arts.

A preferred embodiment of the invention is a display driving apparatus. In this embodiment, the display driving apparatus applied to a panel. The panel displays a first image with a first refresh rate. A first refresh cycle corresponding to the first refresh rate includes a refresh period and at least one non-refresh period. The display driving apparatus includes a real-time determination module and a data processing module. The real-time determination module is coupled to the panel and used to immediately determine whether the panel wants to replace the originally displayed first image with a second image during the first refresh cycle. The data processing module is coupled to the real-time determination module and the panel. If a determination result of the real-time determination module is yes, the data processing module immediately controls the panel to start to display the second image at a first time during the first refresh cycle.

In an embodiment, the panel is an active matrix organic light-emitting diode (AMOLED) panel.

In an embodiment, the first time corresponds to a start time of a non-refresh period of the at least one non-refresh period.

In an embodiment, if the determination result of the real-time determination module is no, the data processing module maintains the panel displaying the first image with the first refresh rate.

In an embodiment, the data processing module controls the panel to start to display the second image with the first refresh rate at the first time.

In an embodiment, after the data processing module controls the panel to display the second image at the first time, the data processing module controls the panel to start to display the second image with the first refresh rate at a second time when the first refresh cycle ends.

In an embodiment, when the data processing module controls the panel to start to display the second image at the first time, the real-time determination module immediately determines whether the panel wants to replace the displayed second image with a third image; if the determination result of the real-time determination module is yes, the data processing module controls the panel to immediately start to display the third image after the second image is displayed.

In an embodiment, during the refresh period, the panel is controlled by a gate scan signal and an emission control signal at the same time; during the at least one non-refresh period, the panel is still controlled by the emission control signal, but the panel is not controlled by the gate scan signal.

Another preferred embodiment of the invention is a display driving apparatus operating method. In this embodiment, the display driving apparatus operating method is used for operating a display driving apparatus applied to a panel. The display driving apparatus operating method includes steps of: (a) the panel displaying a first image with a first refresh rate, and a first refresh cycle corresponding to the first refresh rate including a refresh period and at least one non-refresh period; (b) during the first refresh cycle, immediately determining whether the panel wants to replace the originally displayed first image with a second image; and (c) if a determination result of the step (b) is yes, immediately controlling the panel to start to display the second image at a first time during the first refresh cycle.

Compared to the prior art, the display driving apparatus and the operating method thereof according to the invention can not only reduce the power consumption by reducing the display refresh rate of the panel, but also immediately detect the change of the display data in the display mode with low refresh rate and immediately refresh the display screen. Even in the case of continuous frame refreshing, the display driving apparatus and the operating method thereof according to the invention can maintain a high display refresh rate of the panel to maintain its display quality. In addition, during the non-refresh period, although other display signals related to the self-luminous panel stop functioning, the emission control signal for controlling the light-emitting time of the OLED will continue to operate, thereby avoiding the flickering of the self-luminous display panel.

The advantage and spirit of the invention may be understood by the following detailed descriptions together with the appended drawings.

### BRIEF DESCRIPTION OF THE APPENDED DRAWINGS

FIG. 1 illustrates a schematic diagram that when the skip frame method is used to reduce the display refresh rate in the prior art, the gate scan signal and the emission control signal are both in the normal operation state during the refresh period and both in the stop-operation state during the non-refresh period.

FIG. 2 illustrates a schematic diagram that when the display refresh rate is reduced by using the skip frame method in the prior art, a waiting time is required after the second image is written in and then the display screen is refreshed from the originally displayed first image to the second image.

FIG. 3 and FIG. 4 illustrate a functional block diagram and a timing diagram of a display driving apparatus applied to a panel in a preferred embodiment of the invention.

FIG. 5 illustrates a timing diagram of another embodiment of the display driving apparatus in FIG. 3.

FIG. 6 illustrates a timing diagram of still another embodiment of the display driving apparatus in FIG. 3.

FIG. 7 illustrates a flowchart of a display driving apparatus operating method in another embodiment of the invention.

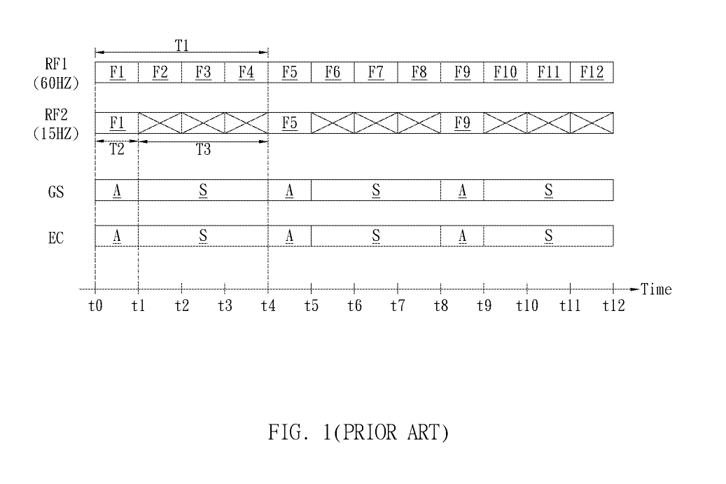

### DETAILED DESCRIPTION OF THE INVENTION

A preferred embodiment of the invention is a display driving apparatus. In this embodiment, the display driving apparatus is applied to a panel, such as an active matrix organic light-emitting diode (AMOLED), but not limited to this.

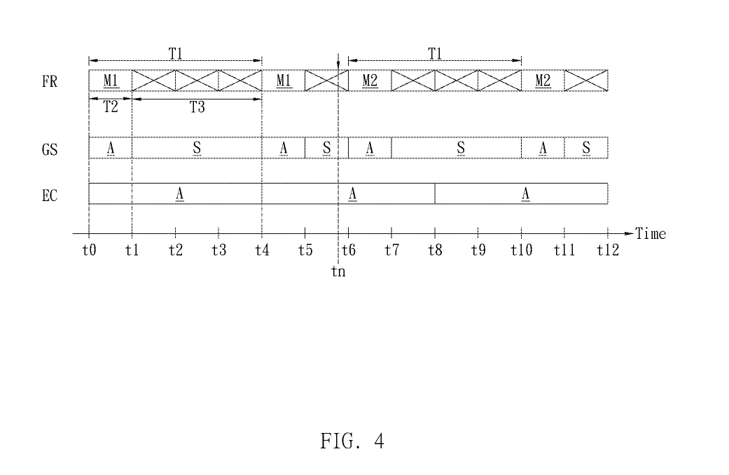

Please refer to FIG. 3 and FIG. 4. FIG. 3 and FIG. 4 illustrate a functional block diagram and a timing diagram of a display driving apparatus applied to a panel in this embodiment.

As shown in FIG. 3, the display driving apparatus 3 is coupled to the panel PL. The display driving apparatus 3 includes a real-time determination module 30 and a data processing module 32. The real-time determination module 30 is coupled to the panel PL and the data processing module 32 respectively. The data processing module 32 is coupled to the panel PL and the real-time determination module 30 respectively.

As shown in FIG. 4, it is assumed that the panel PL starts to display a first image M1 with a first display refresh rate (e.g., 15 Hz) at the time t0. A first display refresh cycle T1 corresponding to the first display refresh rate (e.g., 15 Hz) includes a refresh period T2 and a non-refresh period T3 in order.

Taking the first display refresh cycle T1 from the time t0 to the time t4 for example, the refresh period T2 is from the time t0 to the time t1 and the non-refresh period T3 is from the time t1 to the time t4. That is to say, a display frame FR of the panel PL is refreshed to the first image M1 during the refresh period T2 from the time t0 to the time t1; the display frame FR of the panel PL is not refreshed (represented by X in the box in FIG. 4) during the non-refresh period T3 from the time t1 to the time t4. Since the time of the non-refresh period T3 is three times of that of the refresh period T2, it can reduce the conventional display refresh rate (e.g., 60 Hz) without any non-refresh period in the prior art to the first refresh rate (e.g., 15 Hz) in this embodiment to achieve the effect of reducing power consumption.

The real-time determination module 30 is used to immediately determine whether the panel PL intends to replace the originally displayed first image M1 with the second image M2 during the first display refresh period T1. In practical applications, the real-time determination module 30 can perform the determination by detecting whether the output interface of the display driver IC triggers the refreshing of the display image, but not limited to this.

If the output interface of the display driver IC triggers the refreshing of the display image, the real-time determination module 30 can determine that the panel PL wants to replace the originally displayed first image M1 with the second image M2; conversely, if the output interface of the display driver IC does not trigger the refreshing of the display image, the real-time determination module 30 can determine that the panel PL still wants to continue displaying the first image M1.

Taking the time t0 to the time t4 in FIG. 4 for example, since the real-time determination module 30 does not detect the refreshing of the display image from the time t0 to the time t4, the real-time determination module 30 determines that the panel PL still wants to continue displaying the first image M1; therefore, the display frame FR of the panel PL is still the originally displayed first image M1 from the time t4 to the time t5.

Next, from the time t5 to the time t6, the display frame FR of the panel PL is not refreshed. When the real-time determination module 30 detects the refreshing of the display image at a display image refresh time tn between the time t5 and the time t6, the real-time determination module 30 immediately determines that the panel PL intends to replace the originally displayed first image M1 with the second image M2, and the data processing module 32 immediately controls the panel PL to start displaying the second image M2 at the start time (e.g., the time t6) of the next display frame FR until the time t7.

It should be noted that in this embodiment, the data processing module 32 controls the panel PL to start to display the second image M2 with the first display refresh rate (e.g., 15 Hz) at the time t6; that is to say, another first display update period T1 starts from the time t6 until the time t10. From the foregoing, it can be found that the period from the time t6 to the time t7 is the refresh period T2 and the period from the time t7 to the time t10 is the non-fresh period T3.

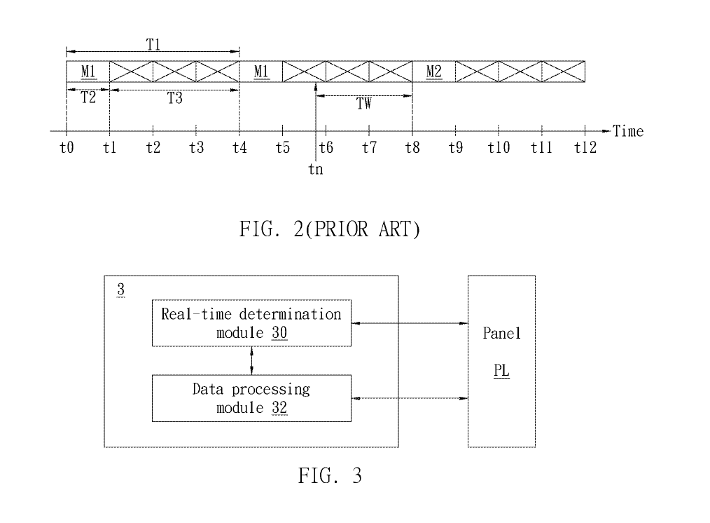

Since the time length from the display image refresh time tn to the time t6 that the panel PL starts to display the second image M2 in FIG. 4 is significantly shorter than the time length of the waiting time TW in the prior art shown in FIG. 2, the invention can effectively improve the condition that the display screen delayed or not smooth when the display refresh rate is low in the prior art.

Similarly, since the real-time determination module 30 does not detect the refreshing of the display image from the time t6 to the time t10, the real-time determination module 30 will determine that the panel PL still wants to continue displaying the second image M2. The display frame FR of the panel PL is still the originally displayed second image M2 from the time t10 to the time t11.

In addition, in this embodiment, it can be also known from FIG. 4 that the gate scan signal GS is in the normal operation state A during the refresh period T2 and it is in the stop-operation state S during the non-refresh period T3, and the emission control signal EC related to the panel display lightness is in the normal operation state A both during the refresh period T2 and during the non-refresh period T3. That is to say, during the refresh period T2, the panel PL is controlled by the gate scan signal GS and the emission control signal EC simultaneously; during the non-refresh period T3, the panel PL is still controlled by the emission control signal EC, but the gate scan signal GS will stop functioning.

For the self-luminous panel (e.g., the AMOLED panel), since the emission control signal EC responsible for controlling the light-emitting time of the OLEDs is in the normal operation state A both during the refresh period T2 and the non-refresh period T3, the lightness of the image displayed by the self-luminous panel during the refresh period T2 and the non-refresh period T3 can be effectively controlled, so as to avoid the flicker phenomenon caused by the large lightness difference.

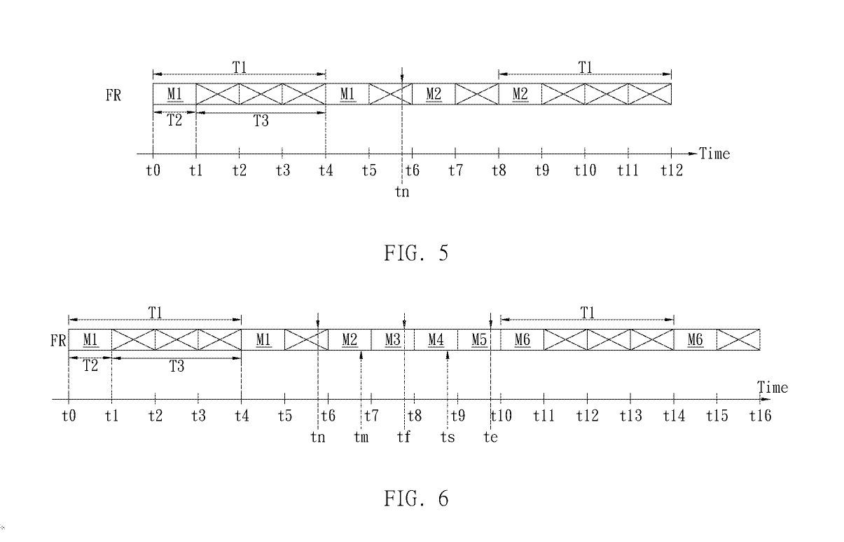

Next, please refer to FIG. 5. FIG. 5 illustrates a timing diagram of another embodiment of the display driving device 3 in FIG. 3. As shown in FIG. 5, when the real-time determination module 30 detects the refreshing of the display image at the display image update time tn between the time t5 to the time t6, the real-time determination module 30 will immediately determine that the panel PL wants to replace the originally displayed first image M1 with the second image M2, and the data processing module 32 immediately controls the panel PL to start displaying the second image M2 at the start time (e.g., the time t6) of the next display frame FR until the time t7.

It should be noted that, in this embodiment, although the data processing module 32 controls the panel PL to start displaying the second image M2 at the time t6, the data processing module 32 does not control the panel PL to start another first display refresh cycle T1 from the time t6. Instead, the data processing module 32 controls the panel PL to start the another first display refresh cycle T1 at the time t8 when the original first display update period T1 ends until the time t12. That is to say, the panel PL is controlled to start displaying the second image M2 with the first display refresh rate (e.g., 15 Hz) from the time t8 until the time t9. From the foregoing, it can be inferred that the period between the time t8 and the time t9 is the refresh period T2 and the period between the time t9 and the time t12 is the non-refresh period T3.

In the above-mentioned embodiments, only the case that the first image is refreshed to the second image is described. Next, the case of continuously refreshing the display image will be described.

As shown in FIG. 6, when the real-time determination module 30 detects the refreshing of the display image at the display image refreshing time tn between the time t5 and the time t6, the real-time determination module 30 will immediately determine that the panel PL wants to replace the originally displayed first image M1 with the second image M2, and the data processing module 32 will immediately control the panel PL to start displaying the second image M2 at the start time (e.g., the time t6) of the next display frame FR until the time t7.

Then, the real-time determination module 30 detects the refreshing of the display image at the display image refreshing time tm between the time t6 and the time t7. The real-time determination module 30 will immediately determine that the panel PL wants to replace the originally displayed second image M2 with the third image M3, and the data processing module 32 immediately controls the panel PL to start displaying the third image M3 at the start time (e.g., the time t7) of the next display frame FR until the time t8.

The real-time determination module 30 detects the refreshing of the display image at the display image refreshing time tf between the time t7 and the time t8. The real-time determination module 30 will immediately determine that the panel PL wants to replace the originally displayed third image M3 with the fourth image M4, and the data processing module 32 immediately controls the panel PL to start displaying the fourth image M4 at the start time (e.g., the time t8) of the next display frame FR until the time t9.

The real-time determination module 30 detects the refreshing of the display image at the display image refreshing time is between the time t8 and the time t9. The real-time determination module 30 will immediately determine that the panel PL wants to replace the originally displayed fourth image M4 with the fifth image M5, and the data processing module 32 immediately controls the panel PL to start displaying the fifth image M5 at the start time (e.g., the time t9) of the next display frame FR until the time t10.

The real-time determination module 30 detects the refreshing of the display image at the display image refreshing time te between the time t9 and the time t10. The real-time determination module 30 will immediately determine that the panel PL wants to replace the originally displayed fifth image M5 with the sixth image M6, and the data processing module 32 immediately controls the panel PL to start displaying the sixth image M6 at the start time (e.g., the time t10) of the next display frame FR until the time t11.

After the display frame FR of the panel PL starts to be continuously refreshed to the second image M2˜the sixth image M6 in sequence at the time t6, since the real-time determination module 30 does not detect the refreshing of the display image from the time t10 to the time t11; therefore, the data processing module 32 can control the panel PL to start displaying the sixth image M6 with the first display refresh rate (e.g., 15 Hz) at the time t10; that is to say, another first display refresh period T1 starts from the time t10 until the time t14. From the foregoing, it can be inferred that the period between the time t10 to the time t11 is the refresh period T2 and the period between the time t11 to the time t14 is the non-refresh period T3.

In addition, since the real-time determination module 30 does not detect the refreshing of the display image between the time t10 and the time t14, the display frame FR of the panel PL is still the sixth image M6 between the time t14 and the time t15.

Another preferred embodiment of the invention is a display driving apparatus operating method. In this embodiment, the display driving apparatus operating method is used for operating a display driving apparatus applied to a panel. And, the panel can be an AMOLED panel, but not limited to this.

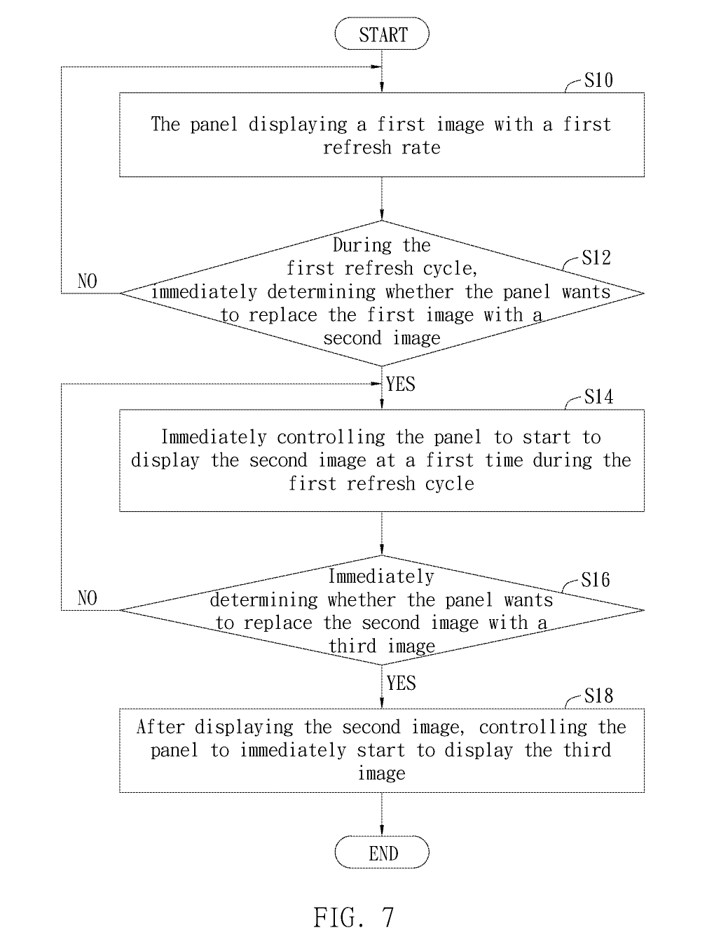

Please refer to FIG. 7. FIG. 7 illustrates a flowchart of a display driving apparatus operating method in this embodiment. As shown in FIG. 7, the display driving apparatus operating method includes the following steps.

Step S10: the panel displaying a first image with a first refresh rate, and a first refresh cycle corresponding to the first refresh rate including a refresh period and at least one non-refresh period.

Step S12: during the first refresh cycle, immediately determining whether the panel wants to replace the originally displayed first image with a second image.

Step S14: if a determination result of the step S12 is yes, immediately controlling the panel to start to display the second image at a first time during the first refresh cycle.

If the determination result of the step S12 is no, then the display driving apparatus operating method will come back to Step S10 to maintain the panel displaying the first image with the first refresh rate.

In fact, the first time can correspond to a start time of a non-refresh period of the at least one non-refresh period, but not limited to this.

In an embodiment, the step S14 controls the panel to start to display the second image with the first refresh rate at the first time.

In another embodiment, after the step S14 controls the panel to display the second image at the first time, the step S14 can also control the panel to start to display the second image with the first refresh rate at a second time when the first refresh cycle ends.

When the panel starts to display the second image at the first time, the display driving apparatus operating method can further includes the following steps.

Step S16: immediately determining whether the panel wants to replace the displayed second image with a third image.

Step S18: if the determination result of the step S16 is yes, controlling the panel to immediately start to display the third image after the second image is displayed.

If the determination result of the step S18 is no, then the display driving apparatus operating method will come back to Step S14 to maintain the panel displaying the second image.

In practical applications, during the refresh period, the panel is controlled by a gate scan signal and an emission control signal at the same time; during the at least one non-refresh period, the panel is still controlled by the emission control signal, but the panel is not controlled by the gate scan signal. Since the emission control signal used for controlling the light-emitting time of the OLED will be continuously operated during the non-refresh period, thereby the flickering of the self-luminous display panel in the prior art can be effectively avoided.

Compared to the prior art, the display driving apparatus and the operating method thereof according to the invention can not only reduce the power consumption by reducing the display refresh rate of the panel, but also immediately detect the change of the display data in the display mode with low refresh rate and immediately refresh the display screen. Even in the case of continuous frame refreshing, the display driving apparatus and the operating method thereof according to the invention can maintain a high display refresh rate of the panel to maintain its display quality. In addition, during the non-refresh period, although other display signals related to the self-luminous panel stop functioning, the emission control signal for controlling the light-emitting time of the OLED will continue to operate, thereby avoiding the flickering of the self-luminous display panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display driving apparatus, applied to a panel displaying a first image with a first refresh rate, and a first refresh cycle corresponding to the first refresh rate comprising a refresh period and at least one non-refresh period, the display driving apparatus comprising:
a real-time determination module, coupled to the panel, for immediately determining whether the panel wants to replace the originally displayed first image with a second image during the first refresh cycle; and
a data processing module, coupled to the real-time determination module and the panel;
wherein if a determination result of the real-time determination module is yes, the data processing module immediately controls the panel to start to display the second image at a first time during the first refresh cycle.

2. The display driving apparatus of claim 1, wherein the panel is an active matrix organic light-emitting diode (AMOLED) panel.

3. The display driving apparatus of claim 1, wherein the first time corresponds to a start time of a non-refresh period of the at least one non-refresh period.

4. The display driving apparatus of claim 1, wherein if the determination result of the real-time determination module is no, the data processing module maintains the panel displaying the first image with the first refresh rate.

5. The display driving apparatus of claim 1, wherein the data processing module controls the panel to start to display the second image with the first refresh rate at the first time.

6. The display driving apparatus of claim 1, wherein after the data processing module controls the panel to display the second image at the first time, the data processing module controls the panel to start to display the second image with the first refresh rate at a second time when the first refresh cycle ends.

7. The display driving apparatus of claim 1, wherein when the data processing module controls the panel to start to display the second image at the first time, the real-time determination module immediately determines whether the panel wants to replace the displayed second image with a third image; if the determination result of the real-time determination module is yes, the data processing module controls the panel to immediately start to display the third image after the second image is displayed.

8. The display driving apparatus of claim 1, wherein during the refresh period, the panel is controlled by a gate scan signal and an emission control signal at the same time; during the at least one non-refresh period, the panel is still controlled by the emission control signal, but the panel is not controlled by the gate scan signal.

9. A display driving apparatus operating method, used for operating a display driving apparatus applied to a panel, the display driving apparatus operating method comprising steps of:
(a) the panel displaying a first image with a first refresh rate, and a first refresh cycle corresponding to the first refresh rate comprising a refresh period and at least one non-refresh period;
(b) during the first refresh cycle, immediately determining whether the panel wants to replace the originally displayed first image with a second image; and
(c) if a determination result of the step (b) is yes, immediately controlling the panel to start to display the second image at a first time during the first refresh cycle.

10. The display driving apparatus operating method of claim 9, wherein the panel is an active matrix organic light-emitting diode (AMOLED) panel.

11. The display driving apparatus operating method of claim 9, wherein the first time corresponds to a start time of a non-refresh period of the at least one non-refresh period.

12. The display driving apparatus operating method of claim 9, further comprising a step of:
if the determination result of the step (b) is no, maintaining the panel displaying the first image with the first refresh rate.

13. The display driving apparatus operating method of claim 9, wherein the step (c) controls the panel to start to display the second image with the first refresh rate at the first time.

14. The display driving apparatus operating method of claim 9, wherein the step (c) further comprises:
controlling the panel to start to display the second image with the first refresh rate at a second time when the first refresh cycle ends.

15. The display driving apparatus operating method of claim 9, further comprising steps of:
(d) when the panel starts to display the second image at the first time, immediately determining whether the panel wants to replace the displayed second image with a third image; and
(e) if the determination result of the step (d) is yes, controlling the panel to immediately start to display the third image after the second image is displayed.

16. The display driving apparatus operating method of claim 9, wherein during the refresh period, the panel is controlled by a gate scan signal and an emission control signal at the same time; during the at least one non-refresh period, the panel is still controlled by the emission control signal, but the panel is not controlled by the gate scan signal.
